(19) United States
(12) Patent Application Publication
(10) Pub. No.: US 2012/0076506 A1
(43) Pub. Date: Mar. 29, 2012

(54) COHERENT OPTICAL RECEIVING APPARATUS AND COHERENT OPTICAL RECEIVING METHOD

(76) Inventors: Yuta Goebuchi, Tokyo (JP); Kouichi Suzuki, Tokyo (JP)

(21) Appl. No.: 13/223,817

(22) Filed: Sep. 1, 2011

(30) Foreign Application Priority Data
Sep. 24, 2010 (JP) 213552/2010

(51) Int. Cl. H04B 10/06

(52) U.S. Cl. 398/202

(57) ABSTRACT

A coherent optical receiving apparatus according to the present invention includes a coherent optical receiving unit to receive a whole of an optical multiplexed signal into which an optical signal is multiplexed, a tunable filter, a local oscillation unit, and a control unit. The coherent optical receiving unit, which includes a 90-degree hybrid circuit and an optoelectric conversion device, selectively detects an optical signal, which interferes with a local oscillation light outputted by the local oscillation unit, out of the optical multiplexed signal. The tunable filter, which is arranged in front of the optoelectric conversion device on an optical path on which the optical multiplexed signal flows, has a bandwidth within which a plurality of optical signals are included. The control unit makes a central wavelength of the tunable filter and a wavelength of the local oscillation light be changed together.

This application is based upon and claims the benefit of priority from Japanese Patent Application No. 2010-213552, filed on Sep. 24, 2010, the disclosure of which is incorporated herein in its entirety by reference.

### TECHNICAL FIELD

The present invention relates to a coherent optical receiving apparatus and a coherent optical receiving method and particularly, relates to a coherent optical receiving apparatus and a coherent optical receiving method to receive an optical multiplexed signal by use of the coherent detection.

### BACKGROUND ART

According to the long-distance optical transmission system, it is realized to transmit a large amount of information by use of WDM (Wavelength Division Multiplexing) transmission technology to multiplex optical signals, which carry electronic signals by use of a plurality of lights whose wavelengths are different each other, and to input the multiplexed optical signals into one optical fiber for transmission. In recent years, the WDM optical transmission system, which is equipped with OADM (Optical Add/Drop Multiplexer) to add and drop any optical signal to and from the WDM signal respectively in a unit of the wavelength, has been developed.

An example of the WDM optical transmission system equipped with OADM is disclosed in Japanese Patent Application Laid-Open No. 2010-035089. According to the related WDM optical transmission system, OADM includes WSS (Wavelength Selective Switch) or AWG (Arrayed Waveguide Grating). However, these optical apparatuses cause a problem to increase a system cost and restrict freedom of design of the WDM optical transmission system.

Meanwhile, the coherent optical transmission system is widely noticed as one of technologies to make bandwidth wider. The coherent optical transmission system has an advantage that it is possible to selectively receive an optical channel whose wavelength is close to that of LO (Local Oscillator) light. By virtue of this advantage, it is possible to input an optical wavelength-division-multiplexed signal (multi channel) directly into a coherent receiving unit not through an optical device such as the optical filter, and to select a desired channel signal by tuning LO light wavelength. Japanese Patent Application Laid-Open No. 2010-109847 discloses a coherent optical receiving unit which can reduce a time required for sweeping the wavelength in order to make the frequency of the LO light and one of the optical signal coincident each other.

### SUMMARY

An exemplary object of the invention is to provide a coherent optical receiving unit and a coherent optical receiving method which can improve S/N ratio of receiving characteristics while preventing increase in system cost even if a configuration where an optical multiplexed signal is received selectively by tuning LO light frequency is adopted.

A coherent optical receiving apparatus according to an exemplary aspect of the invention includes: a coherent optical receiving unit to receive a whole of an optical multiplex signal into which optical signals are multiplexed; a tunable filter; a local oscillation unit which is connected to the coherent optical receiving unit; and a control unit which is connected to the tunable filter and the local oscillation unit. The coherent optical receiving unit, which includes a 90-degree hybrid circuit and an optoelectric conversion device, selectively detects an optical signal, which interferes with local oscillation light outputted by the local oscillation unit, out of the optical multiplexed signal. The tunable filter, which is arranged in front of the optoelectric conversion device and on an optical path on which the optical multiplexed signal flows, has a bandwidth within which a plurality of optical signals are included. The control unit carries out control to make a central wavelength of the tunable filter and a wavelength of the local oscillation light be changed together.

A coherent optical receiving method according to an exemplary aspect of the invention includes: receiving a whole of an optical multiplexed signal into which optical signals are multiplexed; making a wavelength of a desired optical signal be a central wavelength; restraining intensity of the optical multiplexed signal which exists near the central wavelength; detecting the desired optical signal, which interferes with local oscillation light, through carrying out selection out of the optical multiplexed signal; and carrying out control to make the central wavelength and a wavelength of a local oscillation light be changed together.

### BRIEF DESCRIPTION OF THE DRAWINGS

Exemplary features and advantages of the present invention will become apparent from the following detailed description when taken with the accompanying drawings in which:

FIG. 1 is a block diagram showing a configuration of a coherent optical receiving apparatus according to an exemplary embodiment of the present invention;

FIG. 2 is a block diagram showing a configuration of another coherent optical receiving apparatus according to the exemplary embodiment of the present invention;

FIG. 3A is a schematic diagram showing a frequency spectrum of an optical signal in the case that a single channel is received;

FIG. 3B is a schematic diagram showing a frequency spectrum of an optical signal and a frequency characteristic of a tunable filter which are used in the coherent optical receiving unit according to the exemplary embodiment of the present invention in the case that multi channels are received;

FIG. 3C is a schematic diagram showing a frequency spectrum of an optical signal and a frequency characteristic of a tunable filter which are used in the coherent optical receiving unit according to the exemplary embodiment of the present invention in the case that the received channel is changed; and

FIG. 4 shows a relation between BER (bit error rate) and OSNR (Optical Signal to Noise Ratio) of a related coherent optical receiving unit.

### EXEMPLARY EMBODIMENT

An exemplary embodiment of the present invention will be described in the following with reference to drawings.

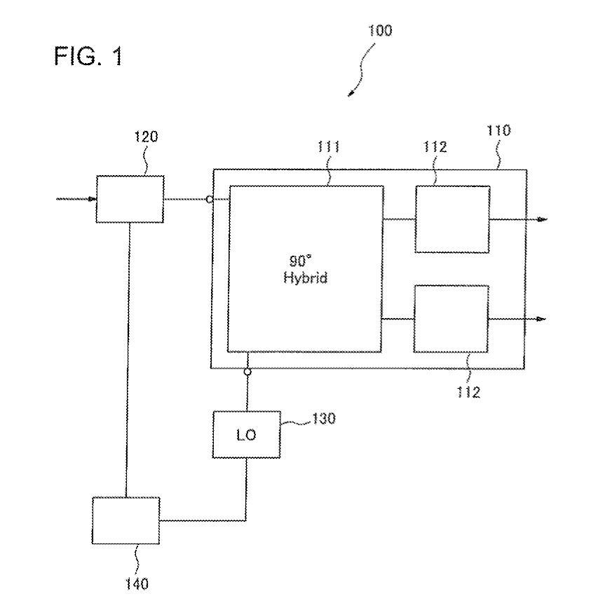

FIG. 1 is a block diagram showing a configuration of a coherent optical receiving apparatus 100 according to the exemplary embodiment. The coherent optical receiving apparatus 100 includes a coherent optical receiving unit 110, a tunable filter 120, a local oscillation unit 130 which is connected to the coherent optical receiving unit 110, and a control unit 140 which is connected to the tunable filter 120 and the local oscillation unit 130.

The coherent optical receiving unit 110, which includes a 90-degree hybrid circuit 111 and a optoelectric conversion device 112, receives the whole of an optical multiplexed signal into which optical signals are multiplexed, and detects an optical signal, which interferes with local oscillation light outputted by the local oscillation unit 130, through carrying out selection out of the optical multiplexed signal, and outputs the detected signal.

The tunable filter 120 is arranged in front of the optoelectric conversion device 112 and on an optical path on which the optical multiplexed signal flows. FIG. 1 shows a case that the tunable filter 120 is arranged in front of the coherent optical receiving unit 110 and on the optical path on which the optical multiplexed signal flows. Moreover, the tunable filter 120 has a bandwidth within which a plurality of wavelengths of optical signals out of the inputted optical multiplexed signal are included. That is, the tunable filter 120 is a broadband type tunable filter. Accordingly, it may be impossible that some tunable filter 120 extracts an optical signal of a certain wavelength out of the optical multiplexed signal, but it is possible to configure the tunable filter 120 with a relatively low cost.

The control unit 140 carries out control to make a central wavelength of the tunable filter 120 and a wavelength of the local oscillation light be changed together. An exemplary case to carry out control so as to make the wavelength of the local oscillation light and the central wavelength of the tunable filter 120 almost equivalent each other will be described in the following. Specifically, the control unit 140 is composed of, for example, a digital arithmetic circuit or the like.

According to the coherent optical receiving apparatus 100 of the exemplary embodiment, intensities of undesired optical signals, which exist far in the frequency domain from the desired optical signal which is detected through carrying out the selection out of the optical multiplex signal, are suppressed by the tunable filter 120. Therefore, it is possible to reduce the beat noise among the undesired optical signals. As a result, it is possible, according to the exemplary embodiment, to improve S/N ratio of receiving characteristics even if the optical multiplexed signal is received selectively by use of the frequency of the local oscillation light.

Moreover, since the coherent optical receiving apparatus 100 according to the exemplary embodiment uses the broadband type tunable filter with the relatively low cost, it is possible to restrain increase of the cost.

According to the coherent optical receiving apparatus 100 of the exemplary embodiment, it is possible to receive the optical signal, which interferes with the local oscillation light, through carrying out the selection of the optical signal out of the optical multiplex light, as mentioned above. Therefore, according to the exemplary embodiment, it is not necessary to use WSS (Wavelength Selector Switch) and AWG (Arrayed Waveguide Grating) in OADM (Optical Add/Drop Multiplexer) of the WDM optical transmission system which is equipped with OADM described in BACKGROUND ART. As a result, it is possible to reduce the cost of the WDM optical transmission system, and to design system more freely.

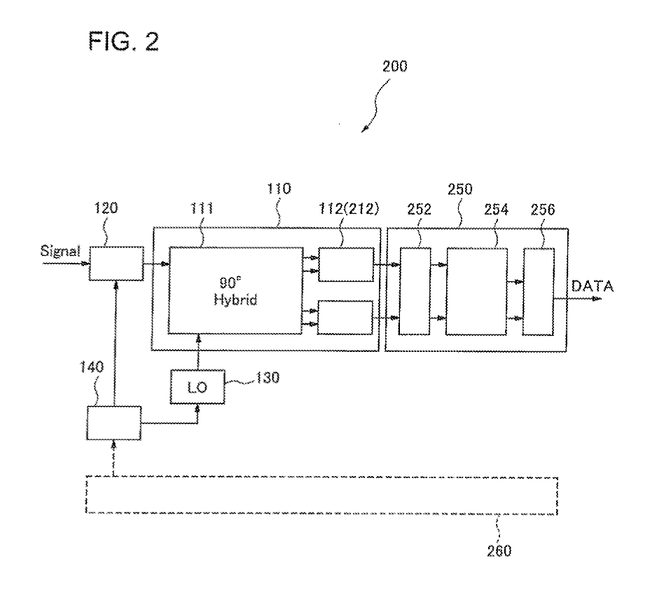

Next, the coherent optical receiving apparatus according to the exemplary embodiment will be described in more detail. FIG. 2 is a block diagram showing a configuration of another coherent optical receiving apparatus 200 according to the exemplary embodiment of the present invention. The coherent optical receiving apparatus 200 has the coherent optical receiving unit 110, the tunable filter 120, the local oscillation unit 130 which is connected to the coherent optical receiving unit 110, and the control unit 140 which is connected to the tunable filter 120 and the local oscillation unit 130. Moreover, the coherent optical receiving unit 110 includes the 90-degree hybrid circuit 111 and the photoelectric conversion device 112. The configuration mentioned above is the same as that of the coherent optical receiving apparatus 100.

Moreover, the coherent optical receiving apparatus 200 includes a signal processing unit 250 which is equipped with an analog-to-digital converter 252, a digital signal processing unit 254 and a judging circuit 256, and which is arranged at the back of the coherent optical receiving unit 110. Moreover, the coherent optical receiving unit 110 employs a differential light detection device 212 as the optoelectric conversion device 112.

Moreover, according to the coherent optical receiving apparatus 200, the control unit 140 receives information on the wavelength of the desired optical signal from the WDM optical transmission system side, for example, a system management unit 260 or the like. The control unit 140 carries out the control to make the wavelength of the local oscillation light which is outputted by the local oscillation unit 130, and the central wavelength of the tunable filter 120 almost equivalent each other, and furthermore, to make both wavelengths tuned to the wavelength of the desired optical signal on the basis of the wavelength information. As a result, the coherent optical receiving apparatus 200 can receive the whole of the optical wavelength-division-multiplexed signal (multi channels), and can receive the optical signal, which interferes with the local oscillation light outputted by the local oscillation unit 130, through carrying out the selection of the signal light out of the optical multiplexed signal.

Next, an operation of the coherent optical receiving apparatus 200 will be described. The coherent optical receiving apparatus 200 employs Mach-Zehnder Interferometer (MZI) as the tunable filter 120. It is possible to change a resonant wavelength (central wavelength) through making a heater, which is on one arm of the MZI, heated and making the equivalent refractive index changed according to the TO effect (Thermo-Optic effect). The control unit 140 carries out control so as to make the central wavelength of the tunable filter 120 coincident with the wavelength of the optical signal on the basis of the information on the wavelength of the optical signal which is acquired from the WDM optical transmission system. While the MZI is employed as the tunable filter 120 according to the configuration, the present embodiment is not limited to the configuration. It is possible to adopt another configuration. It may be preferable, for example, to adopt a configuration including a ring resonator, a configuration including a grating waveguide, a configuration including the MZIs connected in parallel or a configuration including a combination of the MZI and the ring resonator.

Furthermore, the control unit 140 carries out control so as to make the central wavelength of the tunable filter 120 and the wavelength of the local oscillation light, which is outputted by the local oscillation unit 130, almost equivalent each other. As a result, it is possible to make the central wavelength of the tunable filter and the wavelength of the local oscillation light, which is outputted by the local oscillation unit 130, almost equivalent to the wavelength of the optical signal which is acquired from the WDM optical transmission system.

The optical signal, which passes through the tunable filter 120, and the local oscillation light are inputted to the 90-degree hybrid circuit 111. For example, in the case of the optical polarization division multiplexing QPSK (Quadrature Phase Shift Keying) method, the 90-degree hybrid circuit 111 carries out a polarization separating process and an I/Q separating process to separate an in-phase component (I component) and a quadrature component (Q component) respectively out of the optical signal.

The differential light detection device 212, which receives light components whose light phase are 0 degree and 180 degrees (or 90 degrees and 270, degrees), carries out balanced detection for the received light components, and amplifies the balanced-detected light components by use of TransImpedance Amplifier (TIA) or the like, and outputs the amplified light components.

The analog-to-digital converter 252 converts an analog output signal of the differential light detection device 212 into a digital signal. The digital signal processing unit 254 processes the digital signal which is outputted by the analog-to-digital converter 252. Finally, the judging circuit 256 carries out a data judging process, and outputs the judged data as a data signal.

Next, an effect of the exemplary embodiment will be described in more detail. In the case of the coherent optical receiving of the optical multiplexed signal (multi channels), SINR (Signal to Interference and Noise Ratio: sometimes referred to simply as SNR in some cases) can be expressed in the following simplified formula (1).

$$SINR + \frac{〈 {S}^{2} 〉}{〈 {I}^{2} 〉 + 〈 {N}^{2} 〉} \qquad ( 1 )$$

where “S” denotes an intensity component of the optical light and the local oscillation light, and “I” denotes the beat noise among the undesired signals, and “N” denotes the noise component in the coherent receiving.

According to the exemplary embodiment, it is possible to adopt the configuration that the transmission side does not require the filter, as mentioned above. In the case, the coherent optical receiving apparatus receives the whole of the optical wavelength-division-multiplexed signal (multi channels receiving). Accordingly, it is important to reduce the beat noise component <I²> which is included in the denominator of the formula (1), and to increase the optical signal component <S²> which is the numerator of the formula (1), in order to improve SINR (Signal to Interference and Noise Ratio).

As mentioned above, it is possible to reduce the beat noise among the undesired optical signals other than the desired optical signal by virtue of the configuration that the tunable filter is arranged inside the coherent optical receiving apparatus. This will be described in more detail. In the case that one optical receiving unit receives a plurality of the optical signals including a plurality of wavelengths, an interference component, which is called the optical beat noise whose frequency spectrum exists around frequency corresponding to difference between the wavelengths (frequencies) of the optical signals, is generated. In the case of the optical coherent receiving, the noise component can be expressed in the following formula (2).

N=(N_{S}_{_{—}}ₛₕₒₜ+N_{SP}_{_{—}}ₛₕₒₜ+N_{S-SP}+N_{SP-SP}+N_{S-LO}+N_{LO-SP}+Nₜₕ+N_{LO}_{_{—}}ₛₕₒₜ+N_{Id})+(N_{SP}_{_{—}}ₛₕₒₜ+N_{SP-SP}+N_{S-LO}+N_{LO-SP}+Nₜₕ+N_{LO}_{_{—}}ₛₕₒₜ+N_{Id}) (2).

The first member of the formula (2) means the noise component which is generated when the signal is a mark, and the second member means the noise component which is generated when the signal is a space. In the formula (2), N_{S}_{_{—}}ₛₕₒₜ denotes the shot noise of the optical signal, N_{SP}_{_{—}}ₛₕₒₜ denotes the shot noise of Amplified Spontaneous Emission (ASE), and N_{S}_{_{—}}_{SP} denotes the beat noise between the optical signal and ASE, and N_{SP-SP} denotes between ASEs, and N_{S-LO} denotes the beat noise between the optical signal and the local oscillation light, and N_{LO-SP} denotes the beat noise between the local oscillation light and ASE, and Nₜₕ denotes the thermal noise of the circuit, and N_{LO}_{_{—}}ₛₕₒₜ denotes the shot noise of the local oscillation light, and N_{Id} denotes the dark current noise of Photo Diode (PD).

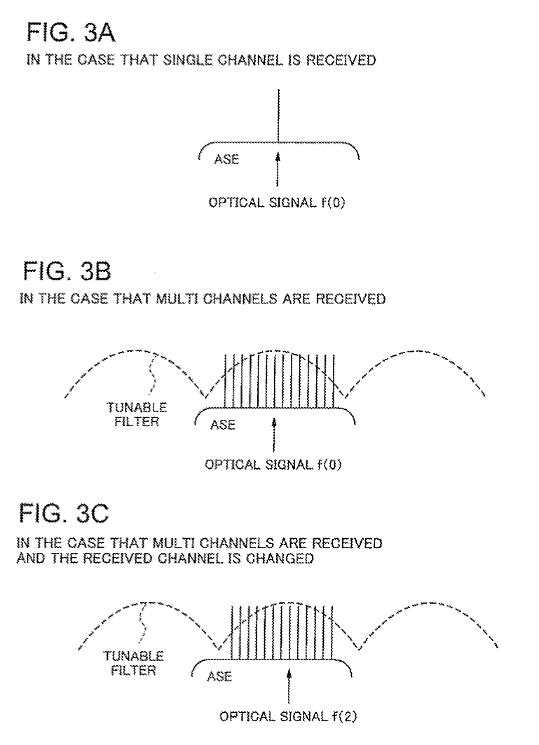

It is possible to reduce the beat noise between ASEs (N_{SP-SP} in the formula (2)) by use of a bandpass filter. The effect is obtained even if the optical signal of one channel is received. Frequency spectrum in the case is shown schematically in FIG. 3A.

Meanwhile, in the case that the optical multiplexed signal (multi channels) is received, the beat noise N_{S′-S′} between the undesired optical signals other than the desired optical signal is also generated. However, it is possible to reduce the beat noise between the undesired optical signals by use of the tunable filter. That is, the intensities for undesired optical signals, which exist far in the frequency domain from the desired optical signal which is detected through carrying out the selection out of the optical multiplexed signal, are suppressed by the tunable filter. Therefore, it is possible to reduce the beat noise between the undesired optical signals. Frequency spectrum in the case is shown schematically in FIG. 3B and FIG. 3C.

In the case of the coherent optical receiving of the optical multiplexed signal (multi channels), SINR (Signal to Interference and Noise Ratio) can be expressed in the following formula (3).

$$SINR = \frac{{P}_{LO} \cdot {P}_{ch}}{\begin{matrix}[ {P}_{LO} \cdot {P}_{n} ] + [ \frac{1}{2} \cdot {( \frac{{R}_{+} - {R}_{-}}{{R}_{+} + {R}_{-}} )}^{2} ( \frac{{R}_{S}}{{f}_{SP}} ) {N}_{ch} \cdot {P}_{ch}^{2} ] + \\ [ \frac{q}{{R}_{+} + {R}_{-}} ( {P}_{LO} + {N}_{ch} \cdot {P}_{ch} ) {R}_{S} ] + [ \frac{4}{{( {R}_{+} + {R}_{-} )}^{2}} \cdot \frac{{kT}_{amp}}{{R}_{L}} {R}_{S} ]\end{matrix}} \qquad ( 3 )$$

where P_{LO} denotes power of the local oscillation light, and P_{ch} denotes power of the optical signal, and Pₙ denotes power of the ASE light, and R₊ and R₋ denote sensitivities (conversion efficiency) of the balanced PDs respectively, and Rₛ denotes ratio of noise to the bandwidth including all channels, and f_{SP} denotes an interval between the optical signals, and N_{ch} denotes number of channels, and q denotes the electric charge, and k denotes the Boltzmann's constant, and Tₐₘₚ denotes amplifier temperature, and R_{L} denotes the transimpedance.

The numerator of the formula (3) is the signal component. The first member to the fourth member of the denominator mean the beat noise between the local oscillation light and ASE, the beat noise between the signals, the shot noise and the thermal noise, respectively. The undesired optical signal is restrained by being passed through the tunable filter, and consequently, the second member of the denominator in the formula (3) becomes small. As a result, it is apparent from the formula (3) that SINR (Signal to Interference and Noise Ratio) at the receiving time is improved.

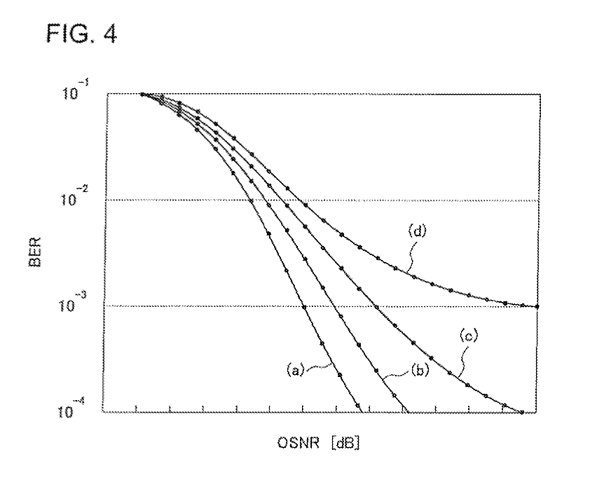

FIG. 4 shows a relation between BER (Bit Error Rate) and OSNR (Optical Signal to Noise Ratio) in the related coherent optical receiving unit with indicating number of channels, which are included in the optical signal, as a parameter. The horizontal axis shows OSNR (Optical Signal to Noise Ratio) on the relative logarithmic scale, and the vertical axis shows BER (Bit Error Rate) on the logarithmic scale. In the figure, (a) to (d) show cases that the number of channels is 1, 32, 64 and 96, respectively.

In the case that OSNR (Optical Signal to Noise Ratio) is small, the ASE noise causes a more severe influence than the interference noise between the channels. As a result, BER (Bit Error Rate) does not depend on the number of channels so much. On the other hand, in the case that OSNR (Optical Signal to Noise Ratio) becomes large, the interference noise between the channels causes a more severe influence than the ASE noise. As a result, it is apparent that BER (Bit Error Rate) is degraded as the number of channels becomes large.

According to the coherent optical receiving apparatus of the present exemplary embodiment, it is possible to reduce the influence of the interference noise between the channels by the tunable filter. As a result, it is possible to process the optical multiplexed signal including more channels.

Meanwhile, it is possible to improve also the intensity component of the optical signal and the local oscillation light (numerator of formula (1)) by virtue of the configuration that the tunable filter is arranged inside the coherent optical receiving apparatus. Hereinafter, the effect will be described in detail.

If it is assumed to receive the whole of optical signals of a plurality of channels which include the optical signal of the undesired channel as mentioned above, an average input power becomes large to reach an input power limit value of the photodiode (PD) even for power of the local oscillation light being relatively small. In contrast, according to the coherent optical receiving apparatus of the present exemplary embodiment, as shown schematically in FIG. 3B, it is possible to restrain power of the undesired optical signal by the tunable filter, and consequently, it is possible to lower the average power of the light which is inputted into the coherent optical receiving apparatus. Since the upper limit value of the light power, which is inputted into the photodiode (PD), is eased as a result, it is possible to enlarge power of the local oscillation light. Consequently, it is possible to increase the optical signal component (numerator of the formula (1)) in the coherent optical receiving unit.

As described above, according to the coherent optical receiving apparatus of the present exemplary embodiment, it is possible to reduce the beat noise between the undesired optical signals and to enlarge the optical signal component. Consequently, it is possible to improve SINR (Signal to Noise Ratio) of the receiving characteristics.

Generally, the coherent optical transmission system receives an Alternating Current (AC) signal component which is amplified through the coherent optical receiving unit mixing Local Oscillation (LO) light and the optical signal together. Since a large amplification effect on the optical signal is obtained in the case as the optical output of the local oscillation unit becomes large, it is possible to obtain the receiving characteristics of high Signal to Noise Ratio (SNR) through inputting the Local Oscillation (LO) light with high power for mixing with the optical signal.

On the other hand, according to the coherent optical transmission system in which the optical apparatus such as the optical filter mentioned above is not employed, the related coherent optical receiving unit receives the whole of the plural optical signals of the plural channels which include the optical signal of the undesired channel not used as the channel signal. Therefore, since the average input power of the optical signals in the related coherent optical receiving unit is increased, it becomes necessary to restrain the optical output of the Local Oscillation (LO) light. As a result, the related coherent optical receiving unit caused the problem that SNR of the receiving characteristics is degraded, in the case of receiving through carrying out the selection out of the optical multiplexed signal by tuning the wavelength of the local oscillation light.

On the other hand, there has been a problem that receiving one optical channel out of the optical multiplexed signal using the tunable filter with narrow bandwidth leads to high cost.

As mentioned above, the related coherent optical receiving unit has caused the problem that SNR, one of the receiving characteristics, is degraded if the desired optical signal is selected from the optical multiplexed signal by tuning the wavelength of the local oscillation light in order to avoid increase of the cost.

An exemplary advantage according to the invention is that it is possible to improve SNR, one of the receiving characteristics, for the configuration where the optical multiplex signal is received by tuning the frequency of the LO light, while suppressing the system cost.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

Further, it is the inventor's intention to retain all equivalents of the claimed invention even if the claims are amended during prosecution.

1. A coherent optical receiving apparatus, comprising:
a coherent optical receiving unit to receive a whole of an optical multiplexed signal into which optical signals are multiplexed;
a tunable filter;
a local oscillation unit which is connected to the coherent optical receiving unit; and
a control unit which is connected to the tunable filter and the local oscillation unit, wherein
the coherent optical receiving unit, which includes a 90-degree hybrid circuit and an optoelectric conversion device, selectively detects an optical signal, which interferes with local oscillation light outputted by the local oscillation unit, out of the optical multiplexed signal, wherein
the tunable filter, which is arranged in front of the optoelectric conversion device and on an optical path on which the optical multiplexed signal flows, has a bandwidth within which a plurality of optical signals are included, and wherein
the control unit makes a central wavelength of the tunable filter and a wavelength of the local oscillation light be changed together.

2. The coherent optical receiving apparatus according to claim 1, wherein
the control unit carries out control so as to make the wavelength of the local oscillation light and the central wavelength of the tunable filter almost equivalent each other.

3. The coherent optical receiving apparatus according to claim 1, wherein
the tunable filter is arranged in front of the coherent optical receiving unit and on the optical path on which the optical multiplex signal flows.

4. The coherent optical receiving apparatus, according to claim 1, further comprising:
a signal processing unit which is arranged at the back of the coherent optical receiving unit, wherein
the signal processing unit includes an analog-to-digital converter, a digital signal processing unit and a judging circuit.

5. A coherent optical receiving method, comprising:
receiving a whole of an optical multiplexed signal into which an optical signal is multiplexed;
making a wavelength of a desired optical signal be a central wavelength;
restraining intensity of the optical multiplexed signal which exists near the central wavelength;
detecting the desired optical signal, which interferes with a local oscillation light, through carrying out selection out of the optical multiplexed signal; and
carrying out control to make the central wavelength and the wavelength of the local oscillation light be changed together.

6. The coherent optical receiving method according to claim 5, further comprising:
carrying out control so as to make the central wavelength and the wavelength of the local oscillation light almost equivalent each other.
